(19) United States
(12) Patent Application Publication
(10) Pub. No.: US 2007/0108645 A1
(43) Pub. Date: May 17, 2007

(54) Method for producing a molded piece

(76) Inventors: Philip Von Schroeter, Rodenbach (DE); Stefan Fecher, Johannesberg (DE)

Correspondence Address: DENNISON, SCHULTZ & MACDONALD, 1727 KING STREET, SUITE 105, ALEXANDRIA, VA, 22314, US

(21) Appl. No.: 10/580,854

(22) PCT Filed: May 25, 2004
(86) PCT No.: PCT/EP04/13359

§ 371 Date: May 26, 2006

(30) Foreign Application Priority Data
Nov. 26, 2003 (EP) 03027104.3
Jun. 4, 2004 (DE) 10 2004 027 558.0

(51) Int. Cl. A61C 13/00

(52) U.S. Cl. 264/16; 264/163

(57) ABSTRACT

The invention refers to a procedure for manufacturing a dental object (24), whereby the object is brought out of a mold blank (26) via machine cutting, and the working is completed with the splitting of a circulating partition wall (32) or a membrane, which runs between the completely worked object and the remaining mold blank.

The invention concerns a method for producing a molded piece, in particular dental objects, such as caps and bridgework, whereby the molded piece is brought out of a molding blank through shape cutting, and the working is concluded by splitting the connection between the molded piece and the remaining molding blank.

With conventional methods of manufacturing artificial crowns and/or bridges, an impression of the jaw is made after a dental preparation in order to produce a positive model of the situation in the mouth with a gypsum impression. On a corresponding so-called master model, a basic structure can be modeled in wax or plastic in order to, for example, achieve a model of the basic structure in metal though smelted wax procedures or copy milling, and, if necessary, overburn with porcelain.

From EP-A-0 389 461, a procedure is taken for manufacturing crown onlays, whereby, first an impression of the tooth cavity to be filled out is taken and then a body, which is sintered to its final density at the production of the onlay, is made through copy milling from a compressed mold blank or before sintering has occurred. However, crowns and bridges are different products compared to onlays, which point to another medical dental indication. Therefore, onlays are fitted in cavities regarding the geometric form. In contrast, crowns and/or bridges pay attention to a tooth stump and take the form of a cap. Through this, thin strands drain, and they are difficult to handle from a technological viewpoint.

From WO-A-199947065, a procedure is known for the manufacture of quality artificial dentures from pressed, fine ceramics powder on at least a pre-prepared stump of the tooth, whereby, with consideration of the shrinkage, the interior surface of a purely ceramic basic structure is calculated from biologically compatible material, as the geometric measurements in the mouth of the patient are scanned and digitized, the data increase linearly in all directions around an enlargement factor, compensating exactly the sinter shrinkage, and then a basic structure with an interior and exterior surface is brought out by removing material from a molding blank.

A corresponding manufacturing process contains a stimulus of the casting to be machine cut and, thereafter, milled and sharpened mostly on its outer sides, whereby, with dental objects, a buccal or lingual stimulus seldom occurs proximal. During the working, the casting is maintained by the stimulus in order to be roughly separated and manually worked, that the wall thickness in the ranges concerned exhibit something of the remaining casting, thus with a dental object exhibiting a cap or bridgework. Concerning soft materials, the reworking is connected with a substantial risk of destruction, whereas with hard materials, a higher time and tool expenditure is needed. Moreover, there is the risk that the wall thickness falls below its recommended limit during the reworking.

According to WO-A-200245615, a dental bridge, for example, is manufactured from a ceramic mold by means of a milling tool which is connected with the remainder of the mold by a retaining bridge.

With a procedure for the manufacture of a technical dental object, such as a crown, a mold is always fixed area-wise in an embedding mass, in order to machine cut from the area not covered by the embedding mass (DE-A-199 30 564).

Alternative procedures for manufacturing dental molded pieces propose a removable base by means of which the molded article to be worked is fixed instead of an outside stimulus.

A stimulus is also unnecessary with the so-called dipping process. Thus, by dipping a model of a tooth stump in a ceramic slip, a bond to the stump is produced, which withstands an external milled working. However, the poor firmness of the ceramic slip, as well as problems of material consistency and storage, are disadvantages.

The present invention takes the problem as a basis to further study a procedure of the type already described, i.e. that a precise working of the mold blank for manufacturing a molded piece, in particular dental objects, such as caps or bridgework is possible without a costly and/or risky rework being necessary. Also, a simple dismantling of the molded piece is possible after it is worked.

For solving the problem, the invention essentially proposes that the molded piece is brought out of the blank mold in such a way that, upon completion of the inner and outer contours of the casting, this remains connected with the mold blank via a connection in the form of a circulating partition wall or membranous connection exhibiting through holes, subsequently, splitting the connection.

In other words, the molded piece is brought out of the blank mold in such a way that, upon completion of the inner and outer contours of the casting, this remains connected further with the mold blank with at least one circulating partition wall or membranous connection, which is subsequently split.

If the connection is a circulating partition wall, in particular, the splitting occurs via circular, i.e. rotating milling. In doing so, the molded piece should be worked in such a way that the circulating partition wall runs on the outer edge of the molded piece of the dental object.

With a working of two sides, namely, occlusal and basal, the circulating partition wall is, in principle, in the range of the largest extent of the cap, usually on or close to its edge.

According to the invention, a shape cutting of a molded piece is suggested with a strategy, by which a working form, for example, pre-sintered or sintered ceramic blank, results in such a way through roughing and smoothing from the inner and outer contour, that the external working of the casting with the removal of the circulating partition wall, which is also termed a circular edge, is concluded, whereby a subsequent reworking becomes fundamentally unnecessary.

Alternatively, the molded piece finished from the inside and outside contour remains connected with the mold blank via a membranous circulating partition wall, which exhibits through holes, and is therefore perforated in order to then rupture the membrane through manual force or by using a tool, such as a scalpel, loosening the molded piece from the mold blank. Then, only a small reworking is required to remove the rest of the retaining membrane.

The thickness of the membranous connection before rupture should preferably be between 50 μm and 500 μm. Through a relevant dimensioning it is ensured that the molded piece cannot be damaged when the mold blank is released.

Since a stimulus, in the sense of the state of the art known before, must not be separated, savings thereby result regarding the machine working. Also, a complex reworking is devoid of the risk that the wall in the area of the connection with the mold blank falls below given values. Rather, according to the invention, a minimization of the risk during manual reworking occurs, since, with a circulating partition wall alone as a connection, a short, circular trimming of the outer edge of the mold blank results; without it, a working of the wall is required. Automation is simplified; also, a simple CAD modeling results. With a retaining membrane as a connection, the rest of the retaining membrane remaining can be removed by scraping or milling with a hand tool.

In particular, it is proposed that, at first, a roughing (coarse milling) of the exterior and then the interior takes place preferably with a meander-shaped, maneuverable milling tool in training the molded piece. Subsequently, a smoothing (fine milling) of the outer and then the inner contour takes place, whereby a circular strategy is preferred.

In the end, a smoothing (fine milling) of the interior or the inner contour can take place, in order to, after a complete working of the molded piece, split the circulating connection (partition wall), which still remains in the outer edge area of the molded piece through a circular milling, as the milling tool is set in its depth.

Alternatively, in the end, a smoothing (fine milling) of the exterior or outer contour of the molded piece can be accomplished, in order to perforate the retaining membrane to thus remove in sections. Finally, the molded piece, also called the milling object, is extracted manually from the mold blank, which is then taken out of the milling machine. Then, the remainder of the split and/or retaining membrane is removed, e.g. by scraping or milling with a hand tool.

According to the procedure proposed by the invention, mold blanks from pre-sintered ceramics, such as zircon oxide and aluminum oxide, as well as sintered ceramics of corresponding materials can be worked. The rotating connection to the mold blank is advantageous as compared to the punctual stimulus required according to the state of the art, which makes a reworking of the casting, such as caps or bridges, necessary at a substantial risk.

The membranous, perforated connection between the molded piece and the mold blank has the advantage that, on the one hand, a simple removal, or extracting, of the molded piece from the mold blank is possible without being damaged, and, on the other hand, only a small reworking on the molded piece itself becomes necessary.

As a result of the theory proposed by the invention, advantages arise especially in the following aspect.
There is a simplification of CAD-construction, e.g. of a cap, bridge, implant or a crown, a primary crown, respectively, since an impetus does not have to be modeled.
An exact reproduction of the outer contour of a cap, bridge, implant or a crown, a primary crown, respectively, results.
Time is saved by minimizing the necessary manual rework.
An improvement of the milling results is possible through uniform, circular, milling tracks on the exterior.
The computation procedure using the NC-Program can be accelerated.
Automation is simplified.
With the perforated, membranous connection between the molded piece (cap, bridge, implant, crown or primary crown) the risk that the minimal necessary wall thicknesses will fall below the range of the connection to the mold blank is avoided.
With a connection in the form of a circulating base, especially a circular edge, objects extracted from the mold blank can be caught directly by a padded retainer without the danger existing of a previous way of striking the casting to the mold blank.

Further details, advantages and characteristics of the invention result not only from the claims, from which these characteristics can be inferred—in and of themselves or in combination—, but also from the following description of an embodiment example, which can be inferred from the design.

They are shown:

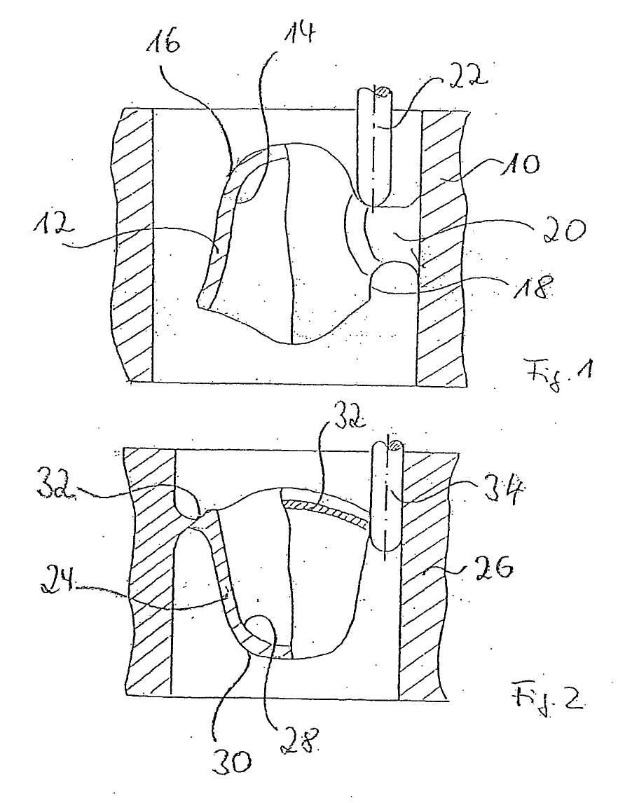

FIG. 1 a principal representation of a cap, worked on according to the state of the art,

FIG. 2. a principal, corresponding representation, according to FIG. 1, of a cap, worked on according to the theory proposed by the invention,

FIG. 3 a principal, corresponding representation, according to FIG. 1, of a further worked cap according to the theory proposed by the invention and

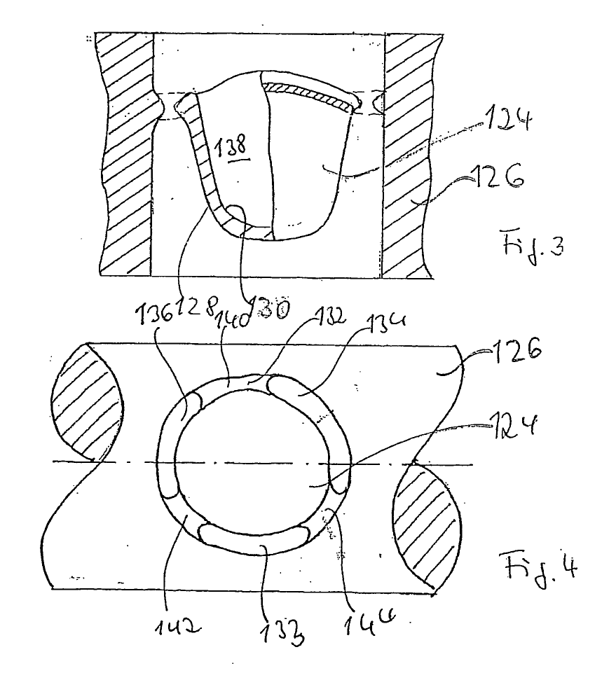

FIG. 4 a top view of the cap pursuant to FIG. 3

In FIG. 1, a cap 12 worked out from a mold blank 10 is represented, which can be manufactured according to the theory of WO-A-199947065, for example. In other words, the cap 12 in worked out from a blank mold 10 in production engineering according to the CAM-process with an inner surface 14, or an inner contour, and an outer surface 16, or an outer contour, by milling.

For this, a positive model is scanned and digitized beforehand. The data obtained are then conveyed to a machine tool, such as a milling tool, in order to work the cap 12 out from the mold blank 10.

According to the state of the art, clarified in FIG. 1, the cap 12 remains connected with the mold blank 10 via a stimulus 20 emanating from an outer side (e.g. buccal or lingual) (see also, FIGS. 7, 9, 10 of WO-A-200245614), which is removed via radiation after the working of the inner surface 14 and the outer surface 16. Due to the strength of the stimulus 20, the disadvantage can arise that the cap 12 tilts away before the final splitting of the stimulus 20, thus deviating in the direction of the mold blank 10, so that the danger arises for the thin-walled sections. After the splitting of the stimulus, a substantial manual working is usually necessary, in order to adapt the wall thickness of the cap 12 in the area of the previous stimuli to the remaining wall thickness.

With soft and/or brittle materials, the risk exists that the wall will burst and/or that the minimal wall thicknesses fall below the limit.

According to the invention, a molded form—a cap 24 in the embodiment example of FIG. 2—can be manufactured from a mold blank 26 pursuant to a suitable CAD/CAM-System, whereby the cap 24, after a complete working of the inner contour 28 and the outer contour 30, remains connected with the mold blank 26 via a circulating, therefore circular edge or base 32. Thus, the circulating partition wall 32 stretches in the outer boundary region of the cap 24 itself. After the completion of the working of the inner and outer contours 28, 30 a splitting of the circulating partition wall 32 results through a circular milling with a tool 34, whereby the tool 34 is set in its depth.

Since the cap 24 is connected with the remaining mold blank 26 by a very narrow partition wall, a milling of the circulating partition wall 32 can take in such a manner that the cap 24 falls down quasi-perpendicular without a change in position and can be caught by a padded retainer. A rework in the separation range, therefore in the outer edge, is only minimally necessary, without the danger of a break or the possibility that unacceptable wall thicknesses may arise.

In order to work the cap 23 out from the mold blank 26, the following milling strategy is preferred: first, a roughing (rough milling) of the exterior and interior surfaces takes place via a meander-shaped movement of the tool. Subsequently, the exterior and interior areas are smoothed in a circular strategy, i.e. worked via fine milling.

With the appropriate steps, a tri-faceted working can be applied with an additional turning possibility of the mold blank 26. Before splitting of the circulating partition wall 32, a smoothing of the inside interiors 28, respectively of the cap 24, takes place. First, the cavity is worked, and then the circulating partition wall and/or edge 32 is split via circular milling.

It should be mentioned that only a small manual working is required to remove the remainder of the base, whereby the risk is minimized. Further advantages are simpler CAD-modeling, shorter milling track computation and simple automation. Furthermore, the finished molded piece is largely completed as one with a stimulus remainder and, thus, of high order.

In the embodiment example of FIGS. 3 and 4, a likewise purely exemplary cap 124 is manufactured from a mold blank 126 pursuant to a suitable CAD-CAM-procedure, whereby the cap 124, after a complete working of the outer contour 128 and the inner contour 130 is connected with the mold blank 126 via a circulating, therefore circular membrane 132, indeed, in particular, in the outer boundary region and preferably in the area of the largest extent of the cap 124. Thus, the membrane 132 is perforated. In the embodiment example, altogether three slot-shaped through holes 133, 134, 136 running along an elbow are proposed.

In order to work out the cap 124 from the mold blank 126, the mold blank 126 is preferably subjected to a tri-faceted mill working, whereby an additional turning axle for the mold blank 126 is proposed. For this, the molding blank 126 can be clamped in a framework not represented.

As a milling strategy, it is intended that a rough milling (roughing) from the inside and outside takes place, whereby a meander-shaped strategy is followed. Subsequently, a fine milling (smoothing) of the external and interior areas takes place, whereby a circular strategy is preferred. After complete working of the inner contour 130, thus the cavity 138 of the cap 124, the retaining membrane, remaining between the mold blank 126 and the designed cap 124, is perforated, while the though holes 133, 134, 136, which follow an elbow, are trained. This can also take place via milling. The length between the remaining bases 140, 142, 144 and the through holes 133, 134, 136 should, preferably, amount to ⅕- 1/20 of the length of the through holes 133, 134, 136. Other dimensions or another number of through holes for creating the perforated retaining membrane 132 are likewise possible.

Independent of this, the retaining membrane 132, as well as the bases 140, 142, 144 should exhibit a thickness of, preferably, 50 μm-500 μm. Then, the mold blank 126 is removed from the tool, i.e. the milling machine, in order to detach the cap 124. This can take place manually or by a knife-like tool, such as a scalpel. Finally, the remainder of the retaining membrane 132 remaining on the exterior of the cap 124, for example, is removed via scraping or milling with a hand tool.

On the basis of the theory proposed by the invention, only a small, manual reworking is required to remove the remainder of the membrane, whereby the risk is minimized. Further advantages can be seen in a simpler CAD-modeling, shorter milling track computation and a simple automation. Furthermore, the molded piece is further finished as such with a partition wall and thus of high order.

If the invention was elucidated upon on the basis of a cap as an embodiment example, then the theory proposed by the invention is also suitable for manufacturing the following molded pieces: bridgework, crowns, primary crowns and inlays, partial crowns and implants implants.

However, the theory proposed by the invention is not only appropriate for manufacturing dental objects. Rather, other applicable parts can a technology. For example, tube-like parts constructed from zircon oxide, which are applicable as reducing sleeves in vacuum engineering, as tubes in medicine, as bearing carriers in machine construction or as insulators in electrical engineering/electronics, come to mind.

Thus, appropriate or similar milling strategies and the corresponding training of a partition wall, respectively of a retaining membrane are conducted.

1. Method for Producing a Molded Piece (24, 124), in particular dental objects, such as caps and bridgework, whereby the molded piece is brought out from a blank mold (26, 126) by machine cutting, and the working is ended with the splitting of a connection (32, 132) between the molded piece and the remaining mold blank, characterized in that the molded piece is brought out from the mold blank (26, 126) in such a way that, at completion of the outer and inner contours (28, 30, 128, 130) of the casting remain connected with blank mold via a connection in the form of a circulating partition wall (32) or a membranous connection exhibiting through holes, and that, subsequently, the connection (132) is split.

2. Procedure according to claim 1,
characterized in
that the circulating partition wall (32) is split via a circular (circulating) milling.

3. Procedure according to claim 1,
characterized in
that the membranous connection (132) is destroyed during manual pressure on the casting.

4. Procedure according to at least one of the previous claims,
characterized in
that the membrane-like connection (132) is split with a knife-like tool, such as a scalpel.

5. Procedure according to at least one of the previous claims,
characterized in
that the membrane-like connection (132) and/or the circulating partition wall (32) is trained in the outer boundary range and, in particular, in the area of the largest extent of the molded piece (124).

6. Procedure according to at least one of the previous claims,
characterized in
that for the manufacture of the molded piece (24, 124), the outer contour (28, 128) and then the inner contour (30, 130) is worked, or, alternatively, the inner contour and then the outer contour is worked.

7. Procedure according to at least one of the previous claims,
characterized in
that, for the manufacture of a molded piece (24, 124), a rough milling takes place first, in particular with a meander-shaped strategy and then a fine milling, in particular with a circular strategy.

8. Procedure according to at least one of the previous claims,
characterized in
that before the connection is split, a smoothing of the inner contour (28, 128) and/or the outer contour (30, 130) takes place.

9. Procedure according to at least one of the previous claims,
characterized in
that directly before splitting the connection (32, 132), the cavity of the molded piece (24, 124) is worked by fine milling.

10. Procedure according to at least one of the previous claims,
characterized in
that the molded piece (24, 124), separated from the mold blank (26, 126) is cleaned circular in the area of removed connection (32, 132).

11. Procedure according to at least one of the previous claims,
characterized in
that, when splitting the circulating partition wall (32), the molded piece (24) from a padded receptacle is caught in a position, which corresponds to the position, or approximately to the position of the molded piece in the mold blank (26).

12. Procedure according to at least one of the previous claims,
characterized in
that, first of all, the cavity of the molded piece (124) is worked and then the membranous connection (132) for training the through holes (133, 134, 136).

13. Procedure according to at least one of the previous claims,
characterized in
that after extracting the molded piece (24, 124) on this, the remainer is removed though manual working, e.g. by scraping and/or milling.

14. Procedure according to at least one of the previous claims,
characterized in
that the through hole (133, 134, 136) is trained as a slot.

15. Procedure according to at least one of the previous claims, characterized in
that the connection (132) is worked in such a way that in this, preferably three elongated through holes (133, 134, 136) are trained following an elbow section or elbow-like section.

16. Procedure according to at least one of the previous claims,
characterized in
that the membrane-like connection (132) is worked in such a way that, within the peripheral range of the molded piece, the length L_{D} of the through holes (133, 134, 136) behave like 1:20≦Lᵥ:L_{D}≦1:5 to the length Lᵥ of the dividing connections between the molded piece and the mold blank.

17. Procedure according to at least one of the previous claims,
characterized in
that the mold blank is mounted rotatable and is worked along three axes by means of a movable milling tool.

18. Procedure according to at least of the previous claims,
characterized in
that materials such as those made from pre-sintered ceramics material, such as zircon oxide or aluminum oxide are used as a mold blank (26, 126).

19. Procedure according to at least one of the previous claims,
characterized in
that materials such as those made from sintered ceramics material, such as zircon oxide or aluminum oxide, are used as a mold blank (26, 126).
